(19) United States
(12) Patent Application Publication
(10) Pub. No.: US 2024/0015309 A1
(43) Pub. Date: Jan. 11, 2024

(54) System, Reception Device, Transmission Device, Method, And Recording Medium Storing Program for Video Communication

(71) Applicant: NJS Co., Ltd., Tokyo (JP)

(72) Inventor: Takeshi Aikawa, Ibaraki (JP)

(21) Appl. No.: 18/250,868

(22) PCT Filed: Oct. 27, 2020
(86) PCT No.: PCT/JP2020/040236

§ 371 Date: Apr. 27, 2023

(51) Int. Cl. H04N 19/176; G06T 7/11

(52) U.S. Cl. CPC H04N 19/176; G06T 7/11

(57) ABSTRACT

A system, a device, a method, a program, and a recording medium with the program recorded thereon, which enable transmitted videos to be reproduced in real time without delay and the reproducibility of videos to be improved are provided. In addition, a system, a device, a method, a program, and a recording medium with the program recorded thereon, which allow states including a degraded communication state to be recognized in a real time manner without delay. A video communication method includes dividing each of a plurality of still image frames of a video including the plurality of still image frames into a plurality of blocks, encoding the plurality of blocks individually on a per block basis, and transmitting an encoded block obtained by encoding a block of the plurality of blocks by a connectionless communication scheme, and reconstructing, for each of the plurality of still image frames, a still image frame by allocating, at a corresponding position, a decoded block generated by decoding the encoded block of one said still image frame, the encoded block being received in an encoded block reception period corresponding to the one still image frame, in which the encoded block reception period is a period from a current frame start time to a time at which a certain time has elapsed, the certain time being obtained by adding a margin time to an expected time for receiving all encoded blocks of one frame.

### TECHNICAL FIELD

The present invention relates to a system, a reception device, a transmission device, a method, a program, and a recording medium with the program recorded thereon for video communication.

### BACKGROUND ART

Techniques have been widely used that perform streaming transmission of live videos of a camera over a network such as the Internet, Ethernet, or a LAN. Such techniques are used in, for example, video conference systems, monitoring camera systems, and remote control systems.

Patent Document 1, JP-A-2008-193510, discloses a technique for transmitting videos of a camera in a real time manner. That is, a video acquired by a camera is encoded and transmitted using a User Datagram Protocol (UDP)/IP protocol. Then, (1) when an error such as a packet loss occurs, a receiving side makes a retransmission request for a packet in which the error has been detected, and an image recovered from the error is decoded and displayed based on the packet transmitted in response to the transmission request, or (2) a video including an error is displayed if real-time performance is to be prioritized.

### CITATION LIST

### Patent Document

Patent Document 1: JP-A-2008-193510

### SUMMARY OF INVENTION

### Technical Problem

A monitoring camera system or a remote control system needs to recognize what is currently happening at a site, and thus is required to be able to check a picture of the site in a real time manner without delay.

In a remote control system, for example, in a case of remote control of an unmanned mobile object such as an unmanned aircraft or an unmanned vehicle equipped with cameras by viewing videos transmitted from the cameras over a wireless LAN, a slight delay may cause a time difference between the actual movement of the unmanned mobile object and the movement of the unmanned mobile object viewed by the operator from the videos, and in the worst case, it may be impossible to prevent the unmanned mobile object from colliding with an obstacle or falling down.

When a state of communication between a video transmission device and a video reception device degrades (e.g., a line failure or degradation of a radio condition), an operator may view a video being displayed without recognizing that the video that the operator has been viewing is a video that has stopped a few seconds earlier (a phenomenon of so-called “freezing images” occurs), and in such a case, the operator cannot immediately recognize the degradation of the communication state and could not stop the unmanned mobile object in response to a significant degradation of the communication state or a state where communication is disabled.

In the technique of the above-mentioned Patent Document 1, when a communication state becomes worse, a packet retransmission request is repeated and a packet delay occurs in the case (1), whereas a packet loss occurs even though packets are received in real time in the case (2). In both cases (1) and (2), if there is a packet that has not been received timely, it may be impossible to decode the entire frame of the packet. In addition, instead of a frame that cannot be fully or partially decoded due to packets that were not been received timely, the previous frame that could be decoded is displayed. As a result, the video being displayed stops as described above, causing the previous image to remain displayed.

Thus, one objective of the present invention is to provide a system, a reception device, a transmission device, a method, a program, and a recording medium with the program recorded thereon, which allow transmitted videos to be reproduced in a real time manner without delay and the reproducibility of videos to be improved.

In addition, another objective of the present invention is to provide a system, a reception device, a transmission device, a method, a program, and a recording medium with the program recorded thereon, which allow states including a degraded communication state to be recognized in a real time manner without delay.

### Solution to Problem

An aspect of the present invention is to provide a video communication method including dividing each of a plurality of still image frames of a video including the plurality of still image frames into a plurality of blocks, encoding the plurality of blocks individually on a per block basis, and transmitting an encoded block obtained by encoding a block of the plurality of blocks by a connectionless communication scheme, and reconstructing, for each of the plurality of still image frames, a still image frame by allocating, at a corresponding position, a decoded block generated by decoding the encoded block of one said still image frame, the encoded block being received in an encoded block reception period corresponding to the one still image frame, in which the encoded block reception period is a period from a current frame start time to a time at which a certain time has elapsed, the certain time being obtained by adding a margin time to an expected time for receiving all encoded blocks of one frame.

The reconstructing the still image frame may include, for each of the plurality of still image frames, reconstructing a still image frame by allocating, at the corresponding position, the decoded block generated by decoding the encoded block of one said still image frame, the encoded block being received in the encoded block reception period corresponding to the one still image frame, and by allocating an image equivalent to a no-image signal to a portion in which the decoded block has not been allocated.

An aspect of the present invention is to provide an image reception method including generating, for each of a plurality of still image frames, a decoded block by decoding an encoded block of one said still image frame, the encoded block being received in an encoded block reception period corresponding to the one still image frame, the encoded block being obtained by dividing each of the plurality of still image frames of a video including the plurality of still image frames into a plurality of blocks, and by encoding the plurality of blocks individually on a per block basis, and the encoded block being transmitted by a connectionless communication scheme, and reconstructing a still image frame by allocating, at a corresponding position, the generated decoded block, in which the encoded block reception period is a period from a current frame start time to a time at which a certain time has elapsed, the certain time being obtained by adding a margin time to an expected time for receiving all encoded blocks of one frame.

The reconstructing of the still image frame may include, for each of the plurality of still image frames, reconstructing a still image frame by allocating, at the corresponding position, the decoded block generated by decoding the encoded block of one said still image frame, the encoded block being received in the encoded block reception period corresponding to the one still image frame, and by allocating an image equivalent to a no-image signal to a portion in which the decoded block has not been allocated.

The reconstructing of the still image frame may include reconstructing a still image frame by allocating, for each of the plurality of still image frames, at the corresponding position, the decoded block generated by decoding the encoded block of one said still image frame, the encoded block being received in the encoded block reception period corresponding to the one still image frame, and for the portion in which the decoded block has not been allocated, by allocating, at the corresponding position, a decoded block at a position corresponding to the portion, among decoded blocks generated by decoding encoded blocks of received past still image frames for each of the past still image frames ranging from a still image frame one-frame prior to the one still image frame to a still image frame a predetermined number of frames prior to the one still image frame, prioritizing a decoded block of a still image frame temporally closer to the one still image frame.

(1) When the encoded block, first transmitted, of the one still image frame is received within the encoded block reception period, a next frame start time may be set to a time corresponding to a time at which one frame time has elapsed from a reception time of the encoded block of the one still image frame first received within the encoded block reception period, and (2) when the encoded block, first transmitted, of the one still image frame is not received and the transmitted encoded block of the one still image frame other than the first transmitted encoded block of the one still image frame is received within the encoded block reception period, a next frame start time may be set to a time at which a certain time has elapsed from a time at which the encoded block of the one still image frame is first received, the certain time being a difference between the one frame time and an expected time for receiving encoded blocks ranging from the first transmitted encoded block of the one still image frame to an encoded block earliest in a transmission order among the encoded blocks of the one still image frame, the encoded blocks being received within the encoded block reception period.

A next frame start time may be set to a time at which one frame time has elapsed from the current frame start time when all of the encoded blocks of the one still image frame are not received within the encoded block reception period.

The plurality of encoded blocks may be transmitted in an order obtained by rearranging a position order of the blocks of the still image frame.

The plurality of encoded blocks may be transmitted in an order obtained by randomly rearranging the position order of the blocks of the still image frame.

An encoding scheme for the video may be a Motion JPEG-based scheme.

The margin time may be a difference between the one frame time and a sum of the expected time for receiving all encoded blocks of the one frame and the drawing time of the one frame in a case that the all blocks of the one frame are decoded.

The expected time for receiving all encoded blocks of the one frame, the expected time for receiving encoded blocks ranging from the first transmitted encoded block of the one still image frame to the earliest encoded block in the transmission order among the encoded blocks of the one still image frame, the encoded blocks being received within the encoded block reception period, and/or the drawing time may be determined based on a corresponding measured value, and may be updated at a predetermined timing during reception of the video.

A value of the expected time for receiving all encoded blocks of the one frame, the expected time for receiving encoded blocks ranging from the first transmitted encoded block of the one still image frame to the earliest encoded block in the transmission order among the encoded blocks of the one still image frame, the encoded blocks being received within the encoded block reception period, and/or the drawing time to be determined based on a corresponding measured value, may be updated at a predetermined timing during reception of the video.

An aspect of the present invention is to provide an image transmission method including dividing each of a plurality of still image frames of a video including the plurality of still image frames into a plurality of blocks, encoding the plurality of blocks individually on a per block basis, and transmitting an encoded blocks obtained by encoding a block of the plurality of blocks by a connectionless communication scheme.

An aspect of the present invention is to provide a program causing a computer to execute the method.

An aspect of the present invention is to provide a computer-readable recording medium on which the program is recorded.

An aspect of the present invention is to provide a video communication system including an image dividing unit that divides each of a plurality of still image frames of a video including the plurality of still image frames into a plurality of blocks, an encoding unit that encodes the plurality of blocks individually on a per block basis, a transmitting unit that transmits an encoded block obtained by encoding a block of the plurality of blocks by a connectionless communication scheme, a decoding unit that decodes, for each of the plurality of still image frames, the encoded block of one said still image frame received in an encoded block reception period corresponding to the one still image frame to generate a decoded block, and a frame reconstruction unit that reconstructs a still image frame by allocating the generated decoded block at a corresponding position, in which the encoded block reception period is a period from a current frame start time to a time at which a certain time has elapsed, the certain time being obtained by adding a margin time to an expected time for receiving all encoded blocks of one frame.

The frame reconstruction unit may reconstruct a still image frame by allocating the generated decoded block at the corresponding position, and allocating an image equivalent to a no-image signal to a portion in which the decoded block has not been allocated.

An aspect of the present invention is to provide an image reception device including a decoding unit that generates a decoded block obtained by decoding, for each of a plurality of still image frames, an encoded block of one said still image frame, the encoded block being received in an encoded block reception period corresponding to the one still image frame, the encoded block being obtained by dividing each of the plurality of still image frames of a video including the plurality of still image frames into a plurality of blocks, and encoding the plurality of blocks individually on a per block basis, and the encoded block being transmitted by a connectionless communication scheme, and

a frame reconstruction unit that reconstructs a still image frame by allocating, at a corresponding position, the generated decoded block, in which the encoded block reception period is a period from a current frame start time to a time at which a certain time has elapsed, the certain time being obtained by adding a margin time to an expected time for receiving all encoded blocks of one frame.

The frame reconstruction unit may reconstruct a still image frame by allocating the generated decoded block at the corresponding position, and allocating an image equivalent to a no-image signal to a portion in which the decoded block has not been allocated.

The frame reconstruction unit may reconstruct a still image frame by allocating, for each of the plurality of still image frames, arranging, at the corresponding position, the decoded block generated by decoding the encoded block of one said still image frame, the encoded block being received in the encoded block reception period corresponding to the one still image frame, and for the portion in which the decoded block has not been allocated, by allocating, at the corresponding position, a decoded block at a position corresponding to the portion, among decoded blocks generated by decoding encoded blocks of received past still image frames for each of the past still image frames ranging from a still image frame one-frame prior to the one still image frame to a still image frame a predetermined number of frames prior to the one still image frame, prioritizing a decoded block of a still image frame temporally closer to the one still image frame.

The image reception device may further include a frame start time setting unit that performs setting such that, (1) when the encoded block, first transmitted, of the one still image frame is received within the encoded block reception period, a next frame start time is set to a time corresponding to a time at which one frame time has elapsed from a reception time of the encoded block of the one still image frame first received within the encoded block reception period, and (2) when the encoded block, first transmitted, of the one still image frame is not received and the transmitted encoded block of the one still image frame other than the first transmitted encoded block of the one still image frame is received within the encoded block reception period, a next frame start time is set to a time at which a certain time has elapsed from a time at which the encoded block of the one still image frame is first received, the certain time being a difference between the one frame time and an expected time for receiving encoded blocks ranging from the first transmitted encoded block of the one still image frame to an encoded block earliest in a transmission order among the encoded blocks of the one still image frame, the encoded blocks being received within the encoded block reception period.

The frame start time setting unit may set a next frame start time to a time at which one frame time has elapsed from the current frame start time when all of the encoded blocks of the one still image frame are not received within the encoded block reception period.

The plurality of encoded blocks may be transmitted in an order obtained by rearranging a position order of the blocks of the still image frame.

The plurality of encoded blocks may be transmitted in an order obtained by randomly rearranging the position order of the blocks of the still image frame.

An aspect of the present invention is to provide an image transmission device including an image dividing unit that divides each of a plurality of still image frames of a video including the plurality of still image frames into a plurality of blocks, an encoding unit that encodes the plurality of blocks individually on a per block basis, and a transmitting unit that transmits an encoded block obtained by encoding a block of the plurality of blocks by a connectionless communication scheme.

An aspect of the present invention is to provide a remote control device including the image transmission device and an imaging device that supplies a video to the image transmission device.

The remote control device may be a mobile object.

The mobile object may be an unmanned mobile object.

In the present specification and the claims, “encode individually” refers to encoding to be performed such that an image can be decoded from only the encoded data. Thus, the encoding scheme using a difference between target encoding units is not an encoding scheme of being individually encoded. For example, an encoding scheme that uses a difference between frames when a target encoding unit is a frame, or an encoding scheme that uses a difference between blocks when a block obtained by dividing a frame is a target encoding unit as in the present invention is not an encoding scheme of being individually encoded. In addition, for example, in the JPEG 2000 scheme, each frame is individually encoded, but each tile constituting a frame is not individually encoded. The reason for this is that each tile cannot be decoded without the information of a main header.

### Advantageous Effects of Invention

According to embodiments of the present invention with the above-described configurations, it is possible to provide a system, a reception device, a transmission device, a method, a program, and a recording medium with the program recorded thereon, which allow transmitted videos to be reproduced in a real time manner without delay and reproducibility of videos to be improved.

In addition, according to embodiments of the present invention with the above-described configurations, it is possible to provide a system, a reception device, a transmission device, a method, a program, and a recording medium with the program recorded thereon, which allow states including a degraded communication state to be recognized in a real time manner without delay.

### BRIEF DESCRIPTION OF DRAWINGS

FIG. 1 is a diagram illustrating an overall configuration of a video communication system according to an embodiment of the present invention.

FIG. 2 is a block diagram illustrating a functional configuration of an image transmission device according to an embodiment of the present invention.

FIG. 3 is a block diagram illustrating a functional configuration of an image reception device according to an embodiment of the present invention.

FIG. 4 is a diagram illustrating a hardware configuration of an image transmission device 10 according to an embodiment of the present invention.

FIG. 5 is a flowchart of an example of an image transmission process according to an embodiment of the present invention.

FIG. 6 is a diagram illustrating an example of block position numbers and block transmission numbers of encoded blocks in one still image frame.

FIG. 7 is a diagram illustrating an example of a data format of a packet.

FIG. 8 is a flowchart of an example of an image reception process according to an embodiment of the present invention.

FIG. 9 is a flowchart of an example of details of a process of setting a next frame start time.

FIG. 10A is a diagram illustrating an example of a reconstructed still image frame.

FIG. 10B is a diagram illustrating another example of the reconstructed still image frame.

FIG. 11 is a diagram illustrating an example of a relationship between time elements related to a setting of a next frame start time when an encoded block transmitted first in one still image frame is received within an encoded block reception period.

FIG. 12 is a diagram illustrating an example of a relationship between time elements related to a setting of a next frame start time when an encoded block transmitted first in one still image frame is not received within an encoded block reception period and another encoded block transmitted in the one still image frame, other than the encoded block transmitted first in the one still image frame, is received within the encoded block reception period.

FIG. 13 is a diagram illustrating an example of a relationship between time elements related to a setting of a next frame start time when all encoded blocks of one still image frame are not received within an encoded block reception period.

### DESCRIPTION OF EMBODIMENTS

Hereinafter, embodiments of the present invention will be described with reference to the drawings.

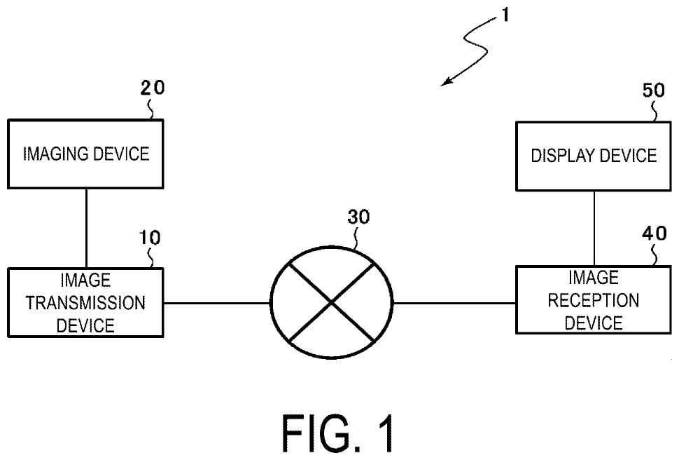

FIG. 1 is a diagram illustrating an overall configuration of a video communication system according to an embodiment of the present invention. The video communication system 1 includes an image transmission device 10, an imaging device 20, a network 30, an image reception device 40, and a display device 50. The image transmission device 10 and the image reception device 40 are connected via a network 30. Each of the image transmission device 10, the imaging device 20, the image reception device 40, and the display device 50 does not need to be configured as one physical device, but may include multiple physical devices.

The imaging device 20 images an object to be imaged, acquires video data, and supplies the video data to the image transmission device 10. The video supplied to the image transmission device 10 may include a plurality of still image frames.

The network 30 may be, for example, a wired/wireless public line network such as the Internet, a telephone network, or a satellite communication network, or any of various types of wired/wireless LAN or WAN including Ethernet (trade name).

Any appropriate device such as a PC, a smartphone, or a tablet terminal in addition to a dedicated device can be used as the image reception device 40.

The display device 50 displays the video data transmitted from the image reception device 40. The display device 50 may be, for example, a CRT display, a liquid crystal display, or an organic EL display.

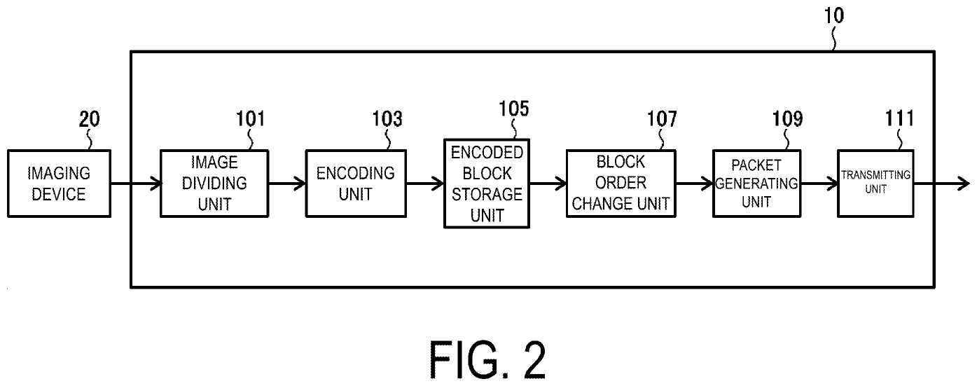

FIG. 2 is a block diagram illustrating a functional configuration of an image transmission device according to an embodiment of the present invention.

The image transmission device 10 includes an image dividing unit 101, an encoding unit 103, an encoded block storage unit 105, a block order change unit 107, a packet generating unit 109, and a transmitting unit 111.

The image dividing unit 101 divides each of a plurality of still image frames of a video including the plurality of still image frames into a plurality of blocks.

The encoding unit 103 encodes a plurality of blocks individually on a per block basis, the plurality of blocks being obtained by dividing, by the image dividing unit 101, each of the plurality of still image frames, and thereby generates encoded blocks. The encoding unit 103 stores the generated encoded blocks in the encoded block storage unit 105 in association with frame numbers and block position numbers.

The encoded block storage unit 105 stores the encoded blocks generated by the encoding unit 103.

The block order change unit 107 randomly rearranges the position order of the encoded blocks of each still image frame stored in the encoded block storage unit 105. The block order change unit 107 assigns block transmission numbers in order from the first one of encoded blocks obtained by changing the order, and stores the block transmission numbers in the encoded block storage unit 105 in association with the encoded blocks.

The packet generating unit 109 reads an encoded block and the frame number, the block transmission number, and the block position number associated with the encoded block from the encoded block storage unit 105, and adds the header including the frame number, the block transmission number, and the block position number to the encoded block to generate a connectionless communication scheme packet.

The transmitting unit 111 transmits the encoded blocks by the connectionless (non-procedural) communication scheme.

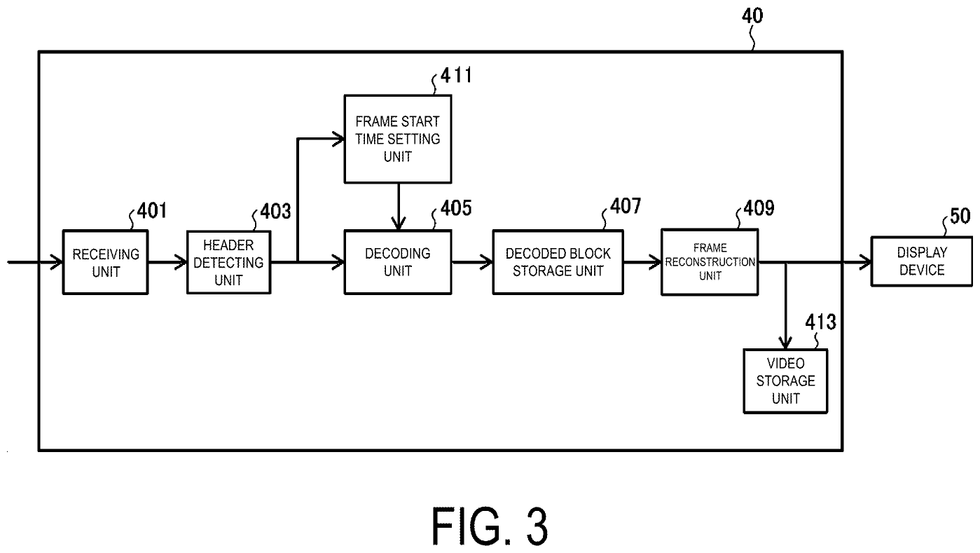

FIG. 3 is a block diagram illustrating a functional configuration of the image reception device according to an embodiment of the present invention.

The image reception device 40 includes a receiving unit 401, a header detecting unit 403, a decoding unit 405, a decoded block storage unit 407, a frame reconstruction unit 409, and a frame start time setting unit 411.

The receiving unit 401 receives packets of encoded blocks transmitted from the image transmission device 10.

The header detecting unit 403 detects a frame number, a block transmission number, and a block position number from the header of a packet, and supplies the numbers to the decoding unit 405 and the frame start time setting unit 411.

For each still image frame, the decoding unit 405 decodes encoded blocks of one still image frame received in an encoded block reception period corresponding to the one still image frame to generate decoded blocks. The decoding unit 405 stores the decoded blocks in the decoded block storage unit 407 together with the frame numbers, block transmission numbers, and block position numbers corresponding to the decoded blocks.

The decoded block storage unit 407 stores the decoded blocks together with the frame numbers, block transmission numbers, and block position numbers corresponding to the decoded blocks.

The frame reconstruction unit 409 allocates the decoded blocks generated by the decoding unit 405 at the corresponding positions, and reconstructs a still image frame with other parts considered to be images equivalent to no-image signals. The frame reconstruction unit 409 sequentially transmits the reconstructed still image frames to the display device 50.

A video storage unit 413 stores the still image frames reconstructed by the frame reconstruction unit 409.

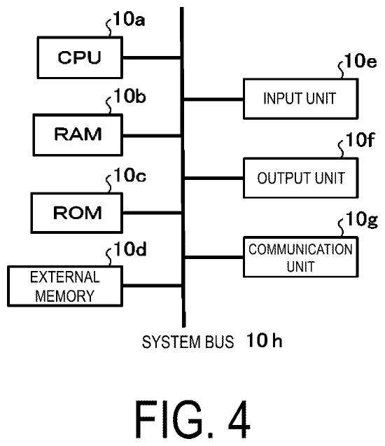

FIG. 4 is a diagram illustrating a hardware configuration of the image transmission device 10 according to an embodiment of the present invention. The image transmission device 10 includes a CPU 10a, a RAM 10b, a ROM 10c, an external memory 10d, an input unit 10e, an output unit 10f, and a communication unit 10g. The RAM 10b, the ROM 10c, the external memory 10d, the input unit 10e, the output unit 10f, and the communication unit 10g are connected to the CPU 10a via a system bus 10h.

The CPU 10a centrally controls each device connected to the system bus 10h.

The ROM 10c and the external memory 10d store a BIOS or an OS that is a control program for the CPU 10a, and various programs, data, and the like necessary for implementing functions executed by a computer.

The RAM 10b functions as a main memory, a work area, and the like for the CPU. The CPU 10a implements various operations by loading the program or the like necessary for executing processing from the ROM 10c and the external memory 10d in the RAM to execute the loaded program.

The external memory 10d includes, for example, a flash memory, a hard disk, a DVD-RAM, a USB memory, and the like.

The input unit 10e receives an operation instruction from a user, and the like. The input unit 10e includes input devices such as an input button, a keyboard, a pointing device, a wireless remote controller, a microphone, and the like.

The output unit 10f outputs data processed by the CPU 10a, and data stored in the RAM 10b, the ROM 10c, and the external memory 10d. The output unit 10f includes output devices such as a CRT display, an LCD, an organic EL panel, a printer, a speaker, and the like.

The communication unit 10g is an interface for connecting to and communicating with an external device via a network or in a direct manner. The communication unit 10g includes an interface such as a serial interface or a LAN interface.

The similar and/or the same hardware configuration is applied to the image reception device 40.

The respective units of the image transmission device 10 illustrated in FIG. 1 are implemented by the various programs stored in the ROM and the external memory using the CPU, the RAM, the ROM, the external memory, the input unit, the output unit, the communication unit, and the like as sources.

Given the above system configuration, examples of a video communication process of the video communication system according to the embodiments of the present invention will be described below with reference to FIGS. 1 to 13, and the like.

### Image Transmission Process

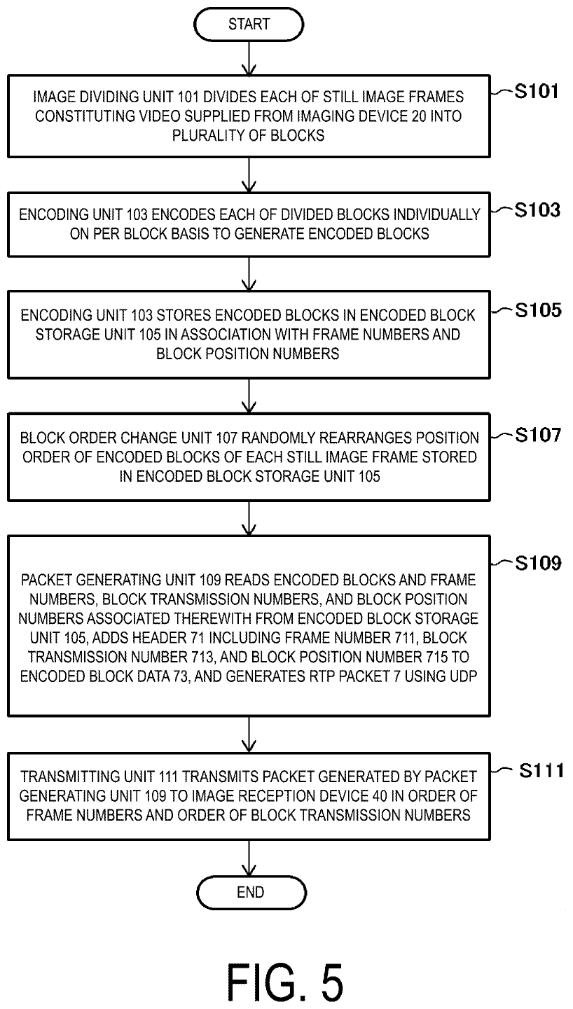

FIG. 5 is a flowchart of an example of an image transmission process according to an embodiment of the present invention.

First, the image dividing unit 101 of the image transmission device 10 divides each of still image frames constituting a video supplied from the imaging device 20 into a plurality of blocks (S101). Then, the encoding unit 103 encodes each of the divided blocks individually on a per block basis to generate an encoded block (S103). The encoding of the video can be performed by, for example, a Motion JPEG-based scheme. That is, in the Motion JPEG-based scheme, each of the still image frames constituting the video is individually encoded/decoded in the JPEG format, and these frames are displayed consecutively to form a video. In the present embodiment, based on the Motion JPEG-based scheme, each of a plurality of blocks obtained by further dividing each still image frame is individually encoded by the JPEG scheme, each encoded block is decoded to reconstruct a still image frame, and the reconstructed still image frames are displayed consecutively to form a video. A video encoding scheme is not limited to the Motion JPEG-based scheme, and any other appropriate scheme may be used as long as each of a plurality of blocks obtained by further dividing each still image frame constituting a video is encoded individually on a per block basis. Here, “being encoded individually” refers to being encoded such that an image can be decoded from only the encoded data. Thus, an encoding scheme using a difference between target encoding units is not an encoding scheme of being individually encoded. For example, an encoding scheme that uses a difference between frames when a target encoding unit is a frame, or an encoding scheme that uses a difference between blocks when a block obtained by dividing a frame is a target encoding unit as in the present invention is not an encoding scheme of being individually encoded. In addition, for example, in the JPEG 2000 scheme, each frame is encoded individually, but each tile constituting a frame is not encoded individually. The reason for this is that each tile cannot be decoded without the information of a main header.

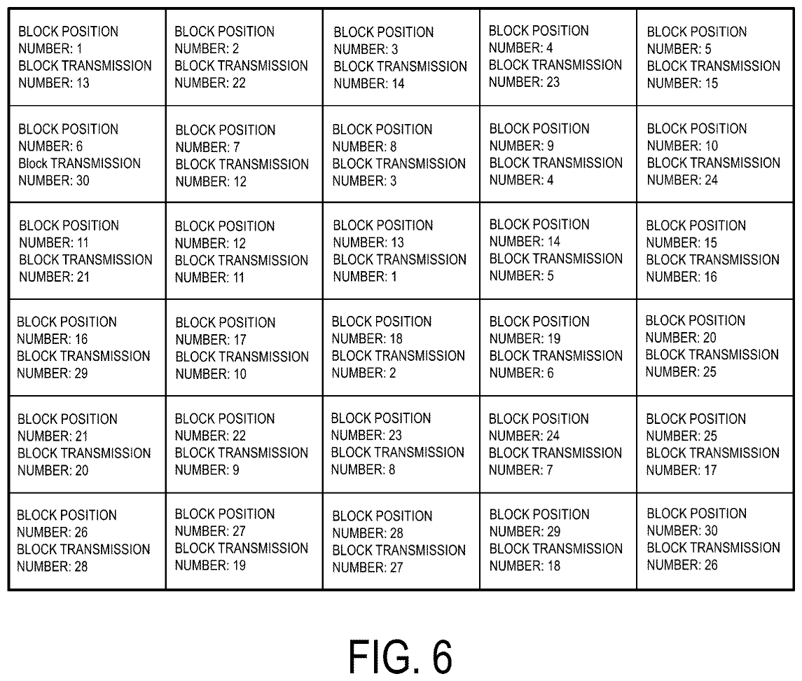

The encoding unit 103 stores the encoded blocks in the encoded block storage unit 105 in association with frame numbers and block position numbers (S105). Here, the frame numbers are serial numbers of the still image frames to which the encoded blocks belong. The block position numbers are numbers given in order of the positions of the encoded blocks in the still image frame, each number indicating the position at which each encoded block is located in each still image frame. In the example illustrated in FIG. 6, the block position numbers are assigned such that, starting from 1 for the block at the upper left corner of the frame, each block is assigned the number in an ascending order as 1, 2, . . . , 30, in a direction from top row to bottom row, from left to right in each row.

The assignment order of the block position numbers is not limited thereto, and any appropriate assignment order can be adopted, for example, starting from 1 for the block at the upper left corner of the frame, each block is assigned the number in an ascending order as 1, 2, . . . , 30, in a direction from left column to right column, from top to bottom in each column.

The block order change unit 107 randomly rearranges the position order of the encoded blocks of each still image frame stored in the encoded block storage unit 105 (S107). Specifically, the order according to the block position numbers of the encoded blocks are randomly changed, and block transmission numbers are assigned to the encoded blocks in an ascending order as 1, 2, . . . , and 30, from the start of the encoded blocks obtained by changing the order and are stored in the encoded block storage unit 105 in association with the encoded blocks. Here, the change of the order of the encoded blocks may be a change, different from a random change, according to a predetermined rule expected to have an effect of allowing non-reproduced portions to be distributedly allocated in reconstructing a still image frame described below. The block order changing process may be omitted.

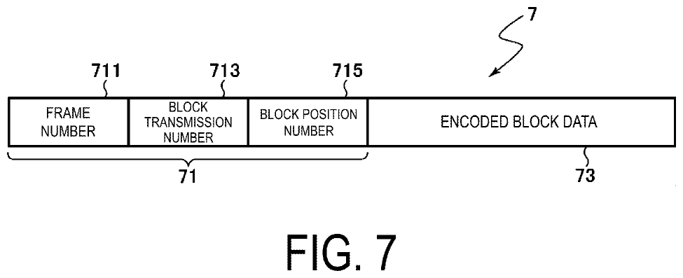

The packet generating unit 109 reads the encoded blocks and the frame numbers, block transmission numbers, and block position numbers associated therewith from the encoded block storage unit 105, adds to encoded block data 73 a header 71 including a frame number 711, a block transmission number 713, and a block position number 715, and generates a Real-time Transport Protocol (RTP) packet 7 using a UDP (S109). FIG. 7 illustrates an example of a data format of the packet 7. Here, the packet is not limited to an RTP packet using the UDP, but may be any other appropriate packet for connectionless communication scheme.

Then, the transmitting unit 111 transmits the packet generated by the packet generating unit 109 to the image reception device 40 via the network 30 in order of the frame numbers and in order of the block transmission numbers (S111).

In the above-described embodiment, as a configuration that allows the encoded blocks to be transmitted in the order with the position order of the blocks in the still image frame rearranged, the configuration is employed such that after the blocks are encoded, the position order of the encoded blocks is rearranged, and the encoded blocks are transmitted. The configuration is not limited thereto, and any appropriate configuration can be adopted. For example, a configuration may be employed that allows, after the position order of the blocks is rearranged before the blocks are encoded, the blocks to be encoded, and the encoded blocks to be transmitted. In such a configuration, the encoded blocks may be transmitted each time one block rearranged before encoding is encoded. According to such a configuration, since the transmission of the encoded blocks is performed more quickly, the delay time can be shortened.

### Image Reception Process

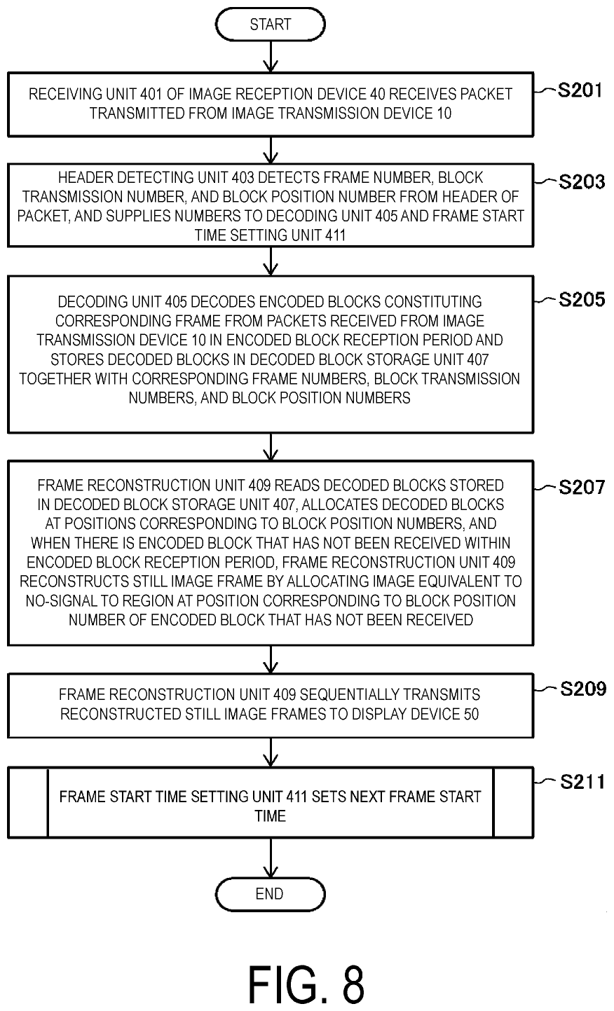

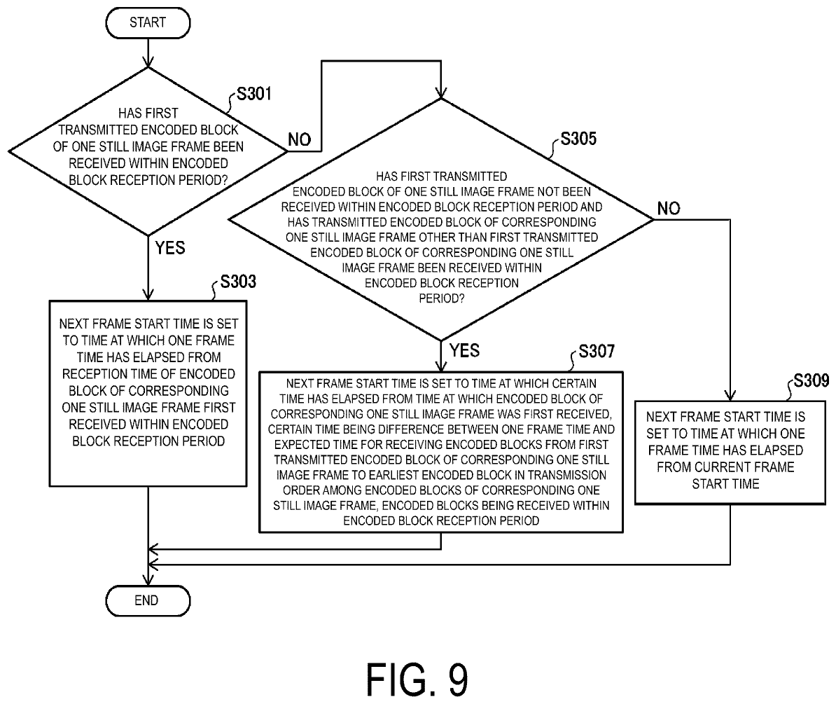

FIG. 8 is a flowchart of an example of an image reception process according to an embodiment of the present invention. In addition, FIG. 9 is a flowchart of an example of details of a process of setting a next frame start time.

The receiving unit 401 of the image reception device 40 receives a packet transmitted from the image transmission device 10 (S201). The header detecting unit 403 detects, from the header of the packet, the frame number, the block transmission number, and the block position number, and supplies the numbers to the decoding unit 405 and the frame start time setting unit 411 (S203).

During an encoded block reception period which is a period from a frame start time until a time lapsed, the time being obtained by adding a margin time to an expected time for receiving all encoded blocks of one frame (an expected time in which all encoded blocks constituting one still image frame are received) and the frame start time being set by the frame start time setting unit 411 to be described below, the decoding unit 405 decodes the encoded blocks constituting the corresponding frame from the packets received from the image transmission device 10 and stores the decoded blocks in the decoded block storage unit 407 together with the corresponding frame numbers, block transmission numbers, and block position numbers (S205). The decoding unit 405 discards a packet received in a period outside the encoded block reception period. When all of the encoded blocks of one still image frame are received before the encoded block reception period elapses, the process may proceed to the next frame reconstruction process (S207) after all of the encoded blocks are decoded, without waiting until the encoded block reception period elapses.

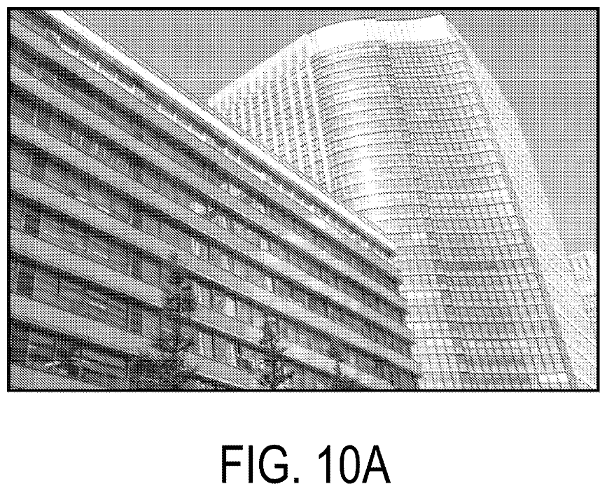

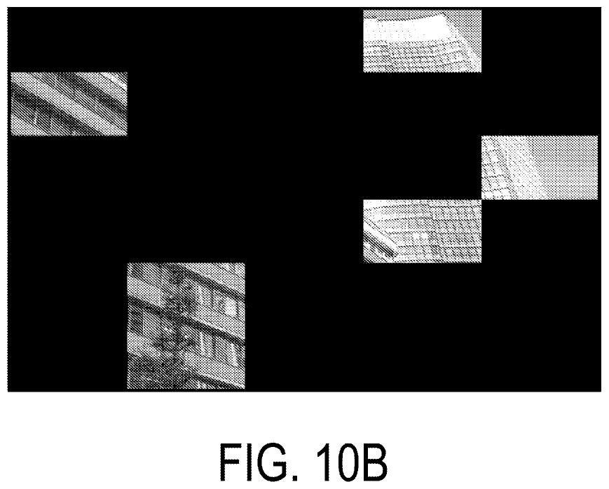

The frame reconstruction unit 409 reads the decoded blocks stored in the decoded block storage unit 407, allocates the decoded blocks at the positions corresponding to the block position numbers, and when there is an encoded block that has not been received within the encoded block reception period, the frame reconstruction unit reconstructs the still image frame by allocating an image equivalent to a no-image signal (e.g., a black image) to a region at the position corresponding to the block position number of the encoded block that has not been received within the encoded block reception period (S207). If all of the encoded blocks are not received within the encoded block reception period, the entire frame is an image equivalent to a no-image signal. The image equivalent to the no-image signal is not limited to a black image, and may be a white image or any other appropriate image. FIG. 10A is an example of a reconstructed frame in a case in which all encoded blocks are received within the encoded block reception period. In addition, FIG. 10B is an example of a reconstructed frame in a case in which some encoded blocks are not received within the encoded block reception period due to a degraded communication state, or the like.

The frame reconstruction unit 409 sequentially transmits the reconstructed still image frames to the display device 50 (S209). At this time, the frame reconstruction unit 409 may cause the video storage unit 413 of the image reception device 40 and/or an external storage device to store the reconstructed still image frames.

The display device 50 displays a video by sequentially displaying the still image frames transmitted from the frame reconstruction unit 409.

Although the decoding unit 405 discards the packet received in a period outside the encoded block reception period in the above embodiment, the decoding unit 405 may receive and decode the packet received in a period outside the encoded block reception period without discarding the packet and store the decoded packet into the decoded block 407, and the frame reconstruction unit 409 may reconstruct, after the encoded block reception period elapses, a still image frame based on the decoded blocks, among the decoded blocks stored in the decoded block 407, obtained by decoding the encoded blocks constituting the corresponding frame from the packets received from the image transmission device 10 in the encoded block reception period.

In the frame reconstruction process, instead of the configuration that reconstructs a still image frame by allocating an image equivalent to a no-image signal to a region at the position corresponding to the block position number of the encoded block that has not been received within the encoded block reception period, following configuration may be employed: reconstructing a still image frame by allocating in a region at the position corresponding to the block position number of the encoded block that has not been received within the encoded block reception period, a decoded block at a position corresponding to a region at a position corresponding to the block position number of the encoded block to be reconstructed that has not been received within the encoded block reception period, among decoded blocks generated by decoding encoded blocks of received past still image frames for each of the past still image frames ranging from a still image frame one-frame prior to the still image frame to be reconstructed to a still image frame a predetermined number of frames prior to the still image frame to be reconstructed, prioritizing a decoded block of a still image frame temporally closer to the still image frame to be reconstructed

the allocation of a decoded block is prioritized among decoded blocks obtained by decoding encoded blocks of the past still image frames received, the past still image frames ranging from a still image frame one-frame prior to the still image frame to be reconstructed to another still image frame a predetermined number of frames prior to the still image frame to be reconstructed, the decoded block being at the position corresponding to the region of the position corresponding to the block position number of the encoded block that has not been received within the encoded block reception period corresponding to the still image frame to be reconstructed, and belonging to a still image frame, among the past still image frames, temporally close to the still image frame to be reconstructed. In this case, the decoding unit 405 receives and decodes the packet received in a period outside the encoded block reception period without discarding the packet, and stores the decoded packet in the decoded block storage unit 407.

For example, in the reconstructed frame illustrated in FIG. 10B, the still image frame is reconstructed by allocating black images that are images equivalent to no-image signals to the regions at positions corresponding to block position numbers other than block position numbers 4, 6, 15, 19, 22, and 27. In the black image portion, decoded blocks at the positions corresponding to the black image portion are allocated, the decoded blocks being decoded blocks among the decoded blocks of the past still image frames ranging from a still image frame one frame prior to the received still image frame to be reconstructed to another still image frame a predetermined number of still image frames prior to the still image frame to be reconstructed. When decoded blocks of a plurality of still image frames are present at the same position, a decoded block of a still image frame that is temporally close to the still image frame to be reconstructed is prioritized. The number of the past still image frames can be set to a small number not to degrade the real-time performance according to the scene. Since the past still image frames often include a decoded block at a position different from the position of the decoded block of the still image frame to be reconstructed, a part or all of the black image portion is displayed by the decoded blocks of the past still image frames. Since the number of the past still image frames is a small number not to degrade the real-time performance, the visibility of the image can be improved without degrading the real-time performance as described above.

The number of the past still image frames can be determined in consideration of balance between required real-time performance and image visibility. If a higher real-time performance is required, the number of the past still image frames may be reduced. That is, the highest real-time performance is implemented if the number of past still image frames is set to one. On the other hand, if the image visibility is to be increased, the number of the past still image frames may be increased, but the real-time performance is degraded accordingly. Therefore, it is possible to increase the image visibility by decreasing the real-time performance to a certain level that can ensure the required real-time performance. With respect to this point, there is a report that a delay is allowed up to about 200 ms in smooth audio-visual communication, and in a delay environment of 120 to 360 ms in a remote control system, an operator gradually gets accustomed to the delay and operations become easy, but operations become extremely difficult from about 480 ms (Shinichi Hamasaki et al., “Implementation and Evaluation of Decorator for Delayed Live Streaming Video on Remote Control System,” Human-Agent Interaction Symposium 2008, 2008). There is a report that the allowable delay value of a picture during a remote operation in a remote-type automatic driving system was 800 ms at the speed of 10 km per hour (Kazuo Mizushima, et al., “Evaluation of Influence of Delay of Image Information on Steering Maneuver in Remotely Controllable Automated Driving System,” the Society of Automotive Engineers of Japan, May 2019, Vol. 50, No. 3). In a case of a drone operation described below, assuming that the drone flies at 1.5 m/s and the operator attempts to stop the flight approximately 2 meters ahead of the target arrival point, the operator needs to perform a stop operation 1.33 seconds earlier (2÷1.5≈1.33 s), and assuming the speed of response of the operator is 0.9 seconds to be subtracted from 1.33 seconds, the allowable delay time is approximately 400 ms. Based on the above calculation, the number of the past still image frames can be the number of frames equivalent to a time equal to or less than 800 ms, preferably a time equal to or less than 400 ms, and more preferably a time equal to or less than 200 ms.

On the other hand, the frame start time setting unit 411 sets the next frame start time (S211). A specific frame start time setting method will be described below.

The frame start time setting unit 411 monitors a block number supplied from the header detecting unit 403. Then, (1) when the encoded block having block number 1, which is the first transmitted encoded block of one still image frame, is received within an encoded block reception period tbr corresponding to the one still image frame (S301: Yes), the next frame start time is set to a time corresponding to the time at which one frame time has elapsed from the reception time of the encoded block of the one still image frame first received within the encoded block reception period (S303). That is, the next frame start time is set based on the expression

(next frame start time nTfr)=(reception time Tr of the encoded block of the one still image frame first received within the encoded block reception period)+(one frame time tfr)

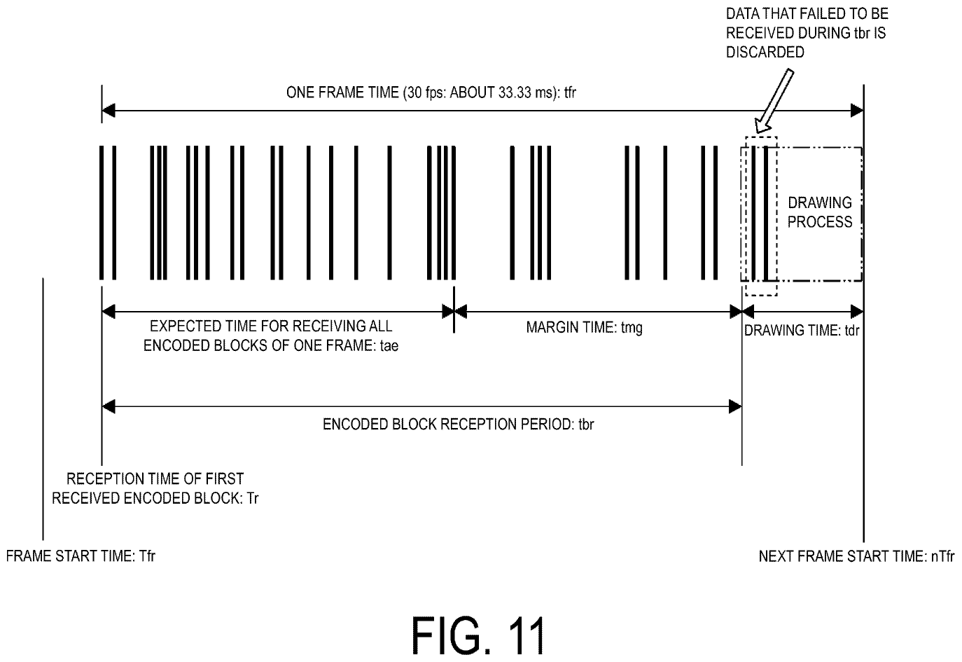

as illustrated in FIG. 11. Here, because the encoded block of the one still image frame received first within the encoded block reception period is usually the first transmitted encoded block of the one still image frame, the time corresponding to the time at which one frame time has elapsed from the reception time of the encoded block of the one still image frame received first within the encoded block reception period may be the time at which one frame time has elapsed from the reception time of the encoded block having the block number 1 which is the first transmitted encoded block of one frame. The time corresponding to the time at which one frame time has elapsed from the reception time of the encoded block of the one still image frame first received within the encoded block reception period is not limited thereto, and may be any other appropriate time.

(2) When the first transmitted encoded block of one still image frame has not been received within the encoded block reception period corresponding to the one still image frame and a transmitted encoded block of the one still image frame other than the first transmitted encoded block of the one still image frame has been received within the encoded block reception period corresponding to the one still image frame (S305: Yes), the next frame start time is set to a time at which a certain time has elapsed from a time at which the encoded block of the one still image frame was first received, the certain time being a time difference between one frame time and an expected time for receiving encoded blocks ranging from the first transmitted encoded block of the one still image frame to the earliest encoded block in the transmission order among the encoded blocks of the one still image frame received within the encoded block reception period (S307). That is, the next frame start time is set based on the expression

(next frame start time nTfr)=(reception time Tr of the first received encoded block)+(one frame time tfr)−(expected time tpe for receiving encoded blocks ranging from the first transmitted encoded block to the earliest encoded block in the transmission order among the received encoded blocks)

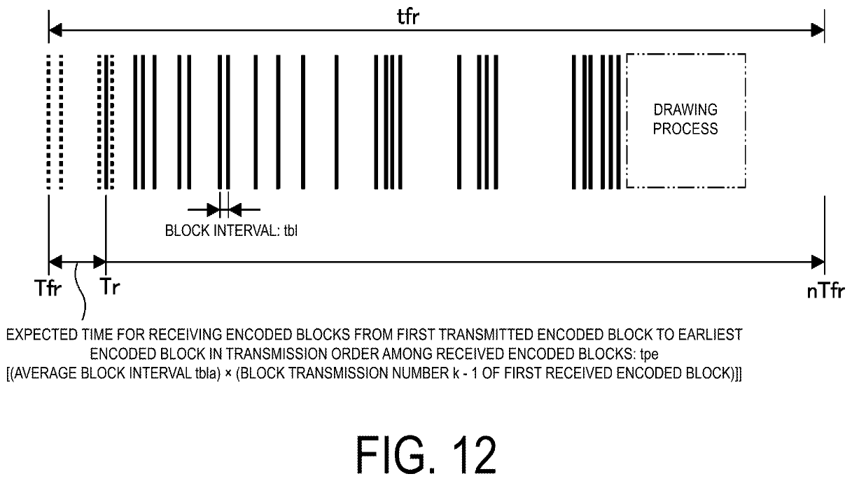

as illustrated in FIG. 12. Here, because the earliest encoded block in the transmission order among the encoded blocks of the one still image frame received within the encoded block reception period is usually the first received encoded block of the one still image frame, the expected time for receiving encoded blocks ranging from the first transmitted encoded block of one still image frame to the earliest encoded block in the transmission order among the encoded blocks of the one still image frame received in the encoded block reception period may be an expected time for receiving encoded blocks ranging from the first transmitted encoded block of one still image frame to the first received encoded block of the one still image frame. The expected time for receiving the first transmitted encoded block of one still image frame to the earliest encoded block in the transmission order among the encoded blocks of the one still image frame received in the encoded block reception period is not limited to thereto, and may be any other appropriate time.

(3) When all of the encoded blocks of one still image frame are not received within the encoded block reception period corresponding to the one still image frame (S305: No), the next frame start time is set to a time at which one frame time has elapsed from the current frame start time (S309). That is, the next frame start time is set based on the expression

(a next frame start time nTfr)=(a current frame start time Tfr)+(one frame time tfr)

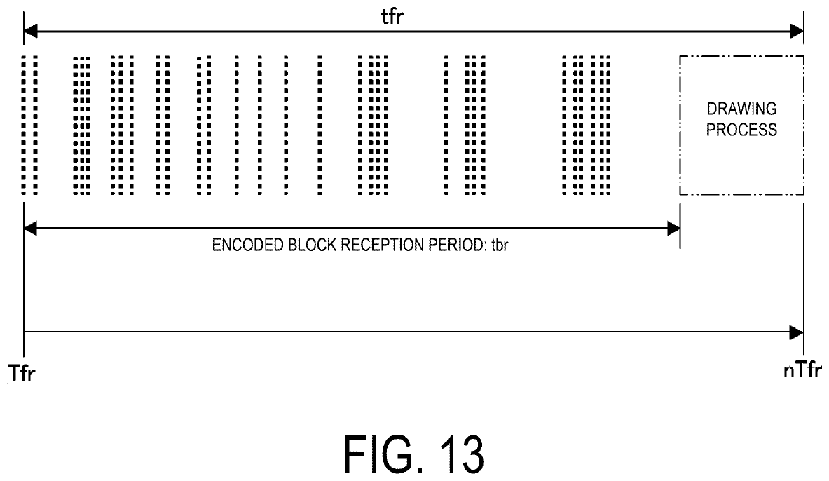

as illustrated in FIG. 13.

As for “one frame time tfr,” “expected time tae for receiving all encoded blocks of one frame,” “expected time tpe for receiving encoded blocks ranging from the first transmitted encoded block of one still image frame to the earliest encoded block in the transmission order among the encoded blocks of the one still image frame received in the encoded block reception period,” and “margin time tmg”, prescribed values may be used, however, if values based on measured values of systems actually used are used, a more appropriate encoded block reception period can be set. Hereinafter, an example in which values based on measured values are used will be described using an example in which a video captured by the imaging device 20 is transmitted from a drone on which the image transmission device 10 and the imaging device 20 are mounted to a PC of an operator including the image reception device 40 and the display device 50 via a wireless LAN and is displayed.

First, in a situation in which the radio conditions are good and all encoded blocks can be received (e.g., before flight is started), actual values are measured, and each value is obtained and set based on the actual measurement values.

An average frame interval is used as the “one frame time tfr.” The average frame interval may be, for example, an average of the measured values of times between reception times of the first transmitted encoded blocks in adjacent frames.

For the “expected time tae for receiving all encoded blocks of one frame,” an average time for receiving all encoded blocks of one frame which is an average of the measured values of the time required for the PC to receive all of the encoded blocks of one frame can be used.

For the “expected time tpe for receiving encoded blocks ranging from the first transmitted encoded block of one still image frame to the earliest encoded block in the transmission order among the encoded blocks of the one still image frame received in the encoded block reception period,” tbla X (k−1) can be used, where “average block interval tbla” is obtained by dividing the above-described “average time for receiving all encoded blocks of one frame” by the number of all blocks of one frame N and the block transmission number of the first received encoded block is set to k.

The “margin time tmg” can be obtained based on the expression margin time tmg =(one frame time tfr)−[(expected time for receiving all encoded blocks of one frame tae) +(drawing time tdr)]. Although the “drawing time tdr” mainly depends on the processing performance of a PC and the performance of rendering software, an average drawing time which is an average of measured values of the time taken for the PC to draw a frame reconstructed based on decoded blocks of all received encoded blocks of one frame may be used.

Then, after flight is started, each value is recalculated, updated, and reset based on the measured values at a predetermined timing. As for the measured values to be used in the recalculation, a value obtained when the radio conditions are bad can be excluded.

Although steps are illustrated in order in the description of the above embodiment, these steps may in some instances be performed in parallel and/or in a different order from those described herein. Further, various steps may be combined with fewer steps, divided into additional steps, and/or eliminated based on a desired embodiment.

According to the present embodiment, since a frame is divided into a plurality of blocks and each of the divided blocks is encoded individually on a per block basis, the error rate of packet can be reduced by reducing the data capacity of packet, and the failure in reproducing an image due to the failure, caused by a packet loss or delay, in receiving a packet can occur in units of blocks that are finer than units of frames, that is, a part of a frame can be reproduced, thus allowing the reception side to reproduce a transmitted video without delay, and the reproducibility of the video to be improved.

According to the present embodiment, it is possible to recognize the conditions of the site including a degraded communication state, and the like, without delay.

According to the present embodiment, since the next frame start time is set based on the reception time of the earliest encoded block in the transmission order among the encoded blocks of the one still image frame received within the encoded block reception period, synchronization can be performed in accordance with communication states, device performance and processing status (e.g., an unstable frame rate of the imaging device, an unstable processing speed and operation of the image transmission device, or an unstable processing speed and operation of the image reception device), and the like, and a more appropriate encoded block reception period can be set, thus allowing more encoded blocks to be received and the reproducibility of images on reception side to be improved.

According to the present embodiment, values of “one frame time tfr,” “expected time tae for receiving all encoded blocks of one frame,” “expected time tpe for receiving encoded blocks ranging from the first transmitted encoded block of one still image frame to the earliest encoded block in the transmission order among the encoded blocks of the one still image frame received in the encoded block reception period,” and “margin time tmg” are determined based on corresponding measured values, thus allowing a more appropriate encoded block reception period to be set and the reproducibility of images on the reception side to be further improved. Since the values based on these measured values are updated at a predetermined timing during the reception of a video, it is possible to set a more appropriate encoded block reception period and to further improve the reproducibility of images on the reception side.

According to the present embodiment, since the encoded blocks are transmitted while the position order of the divided blocks of the still image frame is randomly rearranged, when there is a packet delay, a burst packet loss, or the like, it is possible to prevent a situation in which non-reproduced portions on the reception side mostly reside in a specific part of an image, and the non-reproduced portions can be distributedly allocated, thus improving the visibility.

Although an example in which the imaging device and the image transmission device are mounted on a drone has been described above, embodiments of the present invention are not limited thereto. In particular, when the imaging device and the image transmission device are mounted on an unmanned mobile object such as an unmanned vehicle other than a drone, a mobile object other than an unmanned mobile object, or a remote control device other than a mobile object, the above-described effects can be further achieved.

Hereinabove, some embodiments of the present invention have been described for purposes of illustration, but it will be apparent to those skilled in the art that the present invention is not limited to the embodiments and that various variations and modifications can be made in forms and details without departing from the scope and spirit of the present invention.

### REFERENCE SIGNS LIST

1 Video communication system
10 Image transmission device
101 Image dividing unit
103 Encoding unit
105 Encoded block storage unit
107 Block order change unit
109 Packet generating unit
111 Transmitting unit
10a CPU
10b RAM
10c ROM
10d External memory
10e Input unit
10f Output unit
10g Communication unit
10h System bus
20 Imaging device
30 Network
40 Image reception device
401 Receiving unit
403 Header detecting unit
405 Decoding unit
407 Decoded block storage unit
409 Frame reconstruction unit
411 Frame start time setting unit
50 Display device
6 Still image frame
7 Packet

1. A video communication method comprising:
dividing each of a plurality of still image frames of a video including the plurality of still image frames into a plurality of blocks, encoding the plurality of blocks individually on a per block basis, and transmitting an encoded block obtained by encoding a block of the plurality of blocks by a connectionless communication scheme; and
reconstructing, for each of the plurality of still image frames, a still image frame by allocating, at a corresponding position, a decoded block generated by decoding the encoded block of one said still image frame, the encoded block being received in an encoded block reception period corresponding to the one still image frame; wherein
the encoded block reception period is a period from a current frame start time to a time at which a certain time has elapsed, the certain time being obtained by adding a margin time to an expected time for receiving all encoded blocks of one frame.

2. The video communication method according to claim 1, wherein
the reconstructing the still image frame includes, for each of the plurality of still image frames, reconstructing a still image frame by allocating, at the corresponding position, the decoded block generated by decoding the encoded block of one said still image frame, the encoded block being received in the encoded block reception period corresponding to the one still image frame, and by allocating an image equivalent to a no-image signal to a portion in which the decoded block has not been allocated.

3. An image reception method comprising:
generating, for each of a plurality of still image frames, a decoded block by decoding an encoded block of one said still image frame, the encoded block being received in an encoded block reception period corresponding to the one still image frame, the encoded block being obtained by dividing each of the plurality of still image frames of a video including the plurality of still image frames into a plurality of blocks, and by encoding the plurality of blocks individually on a per block basis, and the encoded block being transmitted by a connectionless communication scheme; and
reconstructing a still image frame by allocating, at a corresponding position, the generated decoded block, wherein
the encoded block reception period is a period from a current frame start time to a time at which a certain time has elapsed, the certain time being obtained by adding a margin time to an expected time for receiving all encoded blocks of one frame.

4. The image reception method according to claim 3, wherein
the reconstructing the still image frame includes, for each of the plurality of still image frames, reconstructing a still image frame by allocating, at the corresponding position, the decoded block generated by decoding the encoded block of one said still image frame, the encoded block being received in the encoded block reception period corresponding to the one still image frame, and by allocating an image equivalent to a no-image signal to a portion in which the decoded block has not been allocated.

5. The image reception method according to claim 3, wherein
the reconstructing the still image frame includes reconstructing a still image frame by allocating, for each of the plurality of still image frames, at the corresponding position, the decoded block generated by decoding the encoded block of one said still image frame, the encoded block being received in the encoded block reception period corresponding to the one still image frame, and for the portion in which the decoded block has not been allocated, by allocating, at the corresponding position, a decoded block at a position corresponding to the portion, among decoded blocks generated by decoding encoded blocks of received past still image frames for each of the past still image frames ranging from a still image frame one-frame prior to the one still image frame to a still image frame a predetermined number of frames prior to the one still image frame, prioritizing a decoded block of a still image frame temporally closer to the one still image frame.

6. The image reception method according to claim 3, wherein
(1) when the encoded block, first transmitted, of the one still image frame is received within the encoded block reception period, a next frame start time is set to a time corresponding to a time at which one frame time has elapsed from a reception time of the encoded block of the one still image frame first received within the encoded block reception period, and
(2) when the encoded block, first transmitted, of the one still image frame is not received and the transmitted encoded block of the one still image frame other than the first transmitted encoded block of the one still image frame is received within the encoded block reception period, a next frame start time is set to a time at which a certain time has elapsed from a time at which the encoded block of the one still image frame is first received, the certain time being a difference between the one frame time and an expected time for receiving encoded blocks ranging from the first transmitted encoded block of the one still image frame to an encoded block earliest in a transmission order among the encoded blocks of the one still image frame, the encoded blocks being received within the encoded block reception period.

7. The image reception method according to claim 3, wherein
a next frame start time is set to a time at which one frame time has elapsed from the current frame start time when all of the encoded blocks of the one still image frame are not received within the encoded block reception period.

8. The image reception method according to claim 3 to 7, wherein
the plurality of encoded blocks are transmitted in an order obtained by rearranging a position order of the blocks of the still image frame.

9. The image reception method according to claim 8, wherein
the plurality of encoded blocks are transmitted in an order obtained by randomly rearranging the position order of the blocks of the still image frame.

10. The image reception method according to claim 3, wherein
an encoding scheme for the video is a Motion JPEG-based scheme.

11. The image reception method according to claim 3, wherein
the margin time is a difference between the one frame time and a sum of the expected time for receiving all encoded blocks of the one frame and the drawing time of the one frame in a case that the all blocks of the one frame are decoded.

12. The image reception method according to claim 6, wherein
the expected time for receiving all encoded blocks of the one frame, the expected time for receiving encoded blocks ranging from the first transmitted encoded block of the one still image frame to the earliest encoded block in the transmission order among the encoded blocks of the one still image frame, the encoded blocks being received within the encoded block reception period, and/or the drawing time is determined based on a corresponding measured value, and is updated at a predetermined timing during reception of the video.

13. The image reception method according to claim 12, wherein
a value of the expected time for receiving all encoded blocks of the one frame, the expected time for receiving encoded blocks ranging from the first transmitted encoded block of the one still image frame to the earliest encoded block in the transmission order among the encoded blocks of the one still image frame, the encoded blocks being received within the encoded block reception period, and/or the drawing time to be determined based on a corresponding measured value, is updated at a predetermined timing during reception of the video.

14. An image transmission method comprising:
dividing each of a plurality of still image frames of a video including the plurality of still image frames into a plurality of blocks;
encoding the plurality of blocks individually on a per block basis; and
transmitting an encoded block obtained by encoding a block of the plurality of blocks by a connectionless communication scheme.

15. (canceled)

16. A non-transit computer-readable recording medium the program having instructions, when executed by one or more processors, cause the one or more processor to perform the video communication method according to claim 1.

17. A video communication system comprising:
an image dividing unit configured to divide each of a plurality of still image frames of a video including the plurality of still image frames into a plurality of blocks;
an encoding unit configured to encode the plurality of blocks individually on a per block basis;
a transmitting unit configured to transmit an encoded block obtained by encoding a block of the plurality of blocks by a connectionless communication scheme;
a decoding unit configured to decode, for each of the plurality of still image frames, the encoded block of one said still image frame received in an encoded block reception period corresponding to the one still image frame to generate a decoded block; and
a frame reconstruction unit configured to reconstruct a still image frame by allocating the generated decoded block at a corresponding position, wherein
the encoded block reception period is a period from a current frame start time to a time at which a certain time has elapsed, the certain time being obtained by adding a margin time to an expected time for receiving all encoded blocks of one frame.

18. The video communication system according to claim 17, wherein
the frame reconstruction unit reconstructs a still image frame by allocating the generated decoded block at the corresponding position, and allocating an image equivalent to a no-image signal to a portion in which the decoded block has not been allocated.

19. An image reception device comprising:
a decoding unit configured to generate a decoded block obtained by decoding, for each of a plurality of still image frames, an encoded block of one said still image frame, the encoded block being received in an encoded block reception period corresponding to the one still image frame, the encoded block being obtained by dividing each of the plurality of still image frames of a video including the plurality of still image frames into a plurality of blocks, and encoding the plurality of blocks individually on a per block basis, and the encoded block being transmitted by a connectionless communication scheme; and
a frame reconstruction unit configured to reconstruct a still image frame by allocating, at a corresponding position, the generated decoded block, wherein
the encoded block reception period is a period from a current frame start time to a time at which a certain time has elapsed, the certain time being obtained by adding a margin time to an expected time for receiving all encoded blocks of one frame.

20. The image reception device according to claim 19, wherein
the frame reconstruction unit reconstructs a still image frame by allocating the generated decoded block at the corresponding position, and allocating an image equivalent to a no-image signal to a portion in which the decoded block has not been allocated.

21. The image reception device according to claim 19, wherein
the frame reconstruction unit reconstructs a still image frame by allocating, for each of the plurality of still image frames, at the corresponding position, the decoded block generated by decoding the encoded block of one said still image frame, the encoded block being received in the encoded block reception period corresponding to the one still image frame, and for the portion in which the decoded block has not been allocated, by allocating, at the corresponding position, a decoded block at a position corresponding to the portion, among decoded blocks generated by decoding encoded blocks of received past still image frames for each of the past still image frames ranging from a still image frame one-frame prior to the one still image frame to a still image frame a predetermined number of frames prior to the one still image frame, prioritizing a decoded block of a still image frame temporally closer to the one still image frame.

22. the image reception device according to claim 19, further comprising:
a frame start time setting unit configured to perform setting such that,
(1) when the encoded block, first transmitted, of the one still image frame is received within the encoded block reception period, a next frame start time is set to a time corresponding to a time at which one frame time has elapsed from a reception time of the encoded block of the one still image frame first received within the encoded block reception period, and
(2) when the encoded block, first transmitted, of the one still image frame is not received and the transmitted encoded block of the one still image frame other than the first transmitted encoded block of the one still image frame is received within the encoded block reception period, a next frame start time is set to a time at which a certain time has elapsed from a time at which the encoded block of the one still image frame is first received, the certain time being a difference between the one frame time and an expected time for receiving encoded blocks ranging from the first transmitted encoded block of the one still image frame to an encoded block earliest in a transmission order among the encoded blocks of the one still image frame, the encoded blocks being received within the encoded block reception period.

23. The image reception device according to claim 19, wherein
the frame start time setting unit sets a next frame start time to a time at which one frame time has elapsed from the current frame start time when all of the encoded blocks of the one still image frame are not received within the encoded block reception period.

24. The image reception device according to claim 19, wherein the plurality of encoded blocks are transmitted in an order obtained by rearranging a position order of the blocks of the still image frame.

25. The image reception device according to claim 24, wherein
the plurality of encoded blocks are transmitted in an order obtained by randomly rearranging the position order of the blocks of the still image frame.

26. An image transmission device comprising:
an image dividing unit configured to divide each of a plurality of still image frames of a video including the plurality of still image frames into a plurality of blocks;
an encoding unit configured to encode the plurality of blocks individually on a per block basis; and
a transmitting unit configured to transmit an encoded block obtained by encoding a block of the plurality of blocks by a connectionless communication scheme.

27. A remote control device comprising:
the image transmission device according to claim 26; and
an imaging device configured to supply a video to the image transmission device.

28. The remote control device according to claim 27, wherein
the remote control device is a mobile object.

29. The remote control device according to claim 28, wherein
the mobile object is an unmanned mobile object.

30. A non-transit computer-readable recording medium storing the program having instructions, when executed by one or more processors, cause the one or more processor to perform the video communication method according to claim 3.
